(19) United States
(12) Patent Application Publication
(10) Pub. No.: US 2004/0221705 A1
(43) Pub. Date: Nov. 11, 2004

(54) Guillotine style paper trimmer

(75) Inventors: Jacqueline Vossler, Chicago, IL (US); Chris Chudek, Atlanta, GA (US); Jack Salzman, Chicago, IL (US); Marta Phillips, Fairfield, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: ACME UNITED CORPORATION

(21) Appl. No.: 10/610,312

(22) Filed: Jun. 30, 2003

Related U.S. Application Data
(60) Provisional application No. 60/392,942, filed on Jul. 1, 2002.

(51) Int. Cl. B26D 5/08

(52) U.S. Cl. 83/614; 83/564

(57) ABSTRACT

A paper trimmer has a base, a movable arm pivotally connected to the base, a blade fixedly connected to the base, and a movable blade connected to the movable arm. The paper trimmer also has an inverted paper-orientating guide on the lower edge of the base for reducing the angle to which the movable blade must be lifted in order to raise the movable blade above the plane of the paper. The paper trimmer preferably further has one or more of the following: a blade guard, a handle connected to the movable arm and disposed in perpendicular orientation to the movable arm for providing controlled and ergonomic cutting action, an automatically engaging locking mechanism for securing the movable blade to the base when the paper trimmer is not in operation, and titanium-bonded fixed and movable blades for providing a sharp and durable cutting edge.

### BACKGROUND OF THE INVENTION

This claims priority from U.S. Provisional Patent Application Ser. No. 60/392,942, filed on Jul. 1, 2002.

1. Field of the Invention

The present invention relates generally to paper trimmers. More particularly, the present invention relates to a paper trimmer having improved operational efficiency and improved operational safety.

2. Description of the Prior Art

A paper trimmer is a device by which sheets of paper and similar objects may be cut to a specific size, as determined by the operator. Paper trimmers generally have a base having a top planar surface for supporting paper, a device mounted to the base for measuring the length and width of the paper, and a cutter or cutting means. The base generally has an upper edge opposite the operator, a lower edge close to the operator, and opposite side edges. The cutting means generally has a fixed blade attached to one side edge of the base and a movable blade mounted to a carrier, which is pivotally connected to the base. The movable blade works in a vertical plane transverse to the plane of the fixed cutting blade. The movable blade cooperates with the fixed blade to produce a shearing cut and to remove portions of a paper that project beyond the base.

Conventional paper trimmers have an upper edge loading design in which paper is positioned and stabilized on the upper edge of the paper trimmer base, opposite the operator, and adjacent to the pivot means of the movable blade. Such positioning of the paper at the upper edge of the paper trimmer requires that the end of the movable blade near the operator be lifted high above the base in order to raise the movable blade above the plane of the paper. Raising the movable blade to such extreme angles exposes the cutting blade and thereby poses the risk of personal injury to the operator. The exposed movable blade may also present a safety hazard for an unsupervised child operating the trimmer. A further detriment to the upper edge loading design is that it requires positioning a paper at the first point of intersection of the movable blade and fixed blade. Such positioning may cause the application of torque forces to the paper, as the pressure of the movable blade is applied. The application of such torque forces to the paper may alter the direction and, thus, the accuracy of a cut.

A need therefore exists for a paper trimmer device that avoids the risk of personal injury inherent to conventional paper trimmers. A need also exists for a paper trimmer that improves operational performance by preventing the application of torque forces to a paper to be cut.

### SUMMARY OF THE INVENTION

It is an object of the present invention to provide a paper trimmer having an inverted paper orienting edge that reduces the angle to which the movable blade must be raised above the plane of the paper during a cutting operation, thereby providing safer operation of the paper trimmer.

It is also an object of the present invention to provide an inverted paper orientation that prevents the application of torque forces to the paper during a cutting operation.

It is another object of the present invention to provide a blade guard that protects the operator from exposure to the movable blade when the movable arm is in the raised position.

It is still another object of the present invention to provide a handle on the movable arm, with the handle situated perpendicular to the transverse line of the movable arm, so that the perpendicular handle orientation provides smooth, controlled and ergonomic cutting action.

It is yet another object of the present invention to provide a locking mechanism that automatically engages when the movable blade is in the inactive position, thereby reducing risk of injury to unsupervised children.

It is a further object of the present invention to provide titanium-bonded fixed and movable blades with a stainless steel core for providing sharp blades.

It is a still further object of the present invention to provide titanium-bonded fixed and movable blades having a stainless steel core for providing durable and lasting blades.

These and other objects and advantages are achieved by the guillotine style paper trimmer of the present invention. The paper trimmer has a base, a movable arm connected to the base, a fixed blade positioned on one side of the base, and a movable blade positioned on the movable arm. The present invention also has an inverted paper-orienting guide, positioned on the lower edge of the base. The inverted paper-orienting edge positions the paper near the lower edge of the base, thereby reducing the angle to which the movable blade must be lifted in order to raise the movable blade above the plane of the paper for cutting. The paper trimmer of the present invention also preferably has one or more of the following: a blade guard for protecting the operator from the exposed movable blade; a handle, in perpendicular orientation to the movable arm, for providing controlled and ergonomic cutting action; an automatically engaging locking mechanism for securing the movable blade to the base when the paper trimmer is not in operation; and titanium-bonded fixed and movable blades for providing a sharper, more durable cutting edge.

### BRIEF DESCRIPTION OF THE DRAWINGS

The foregoing and still other objects and advantages of the present invention will be more apparent from the following detailed explanation of the preferred embodiments of the invention in connection with the accompanying drawings.

FIG. 1 illustrates a top view of the paper trimmer of the present invention;

FIG. 2 illustrates a perspective view of the paper trimmer of the present invention, with the movable blade in the neutral position;

FIG. 3 illustrates a side view of the paper trimmer of the present invention, with the movable blade in an active position;

FIG. 4 illustrates a bottom view of the paper trimmer of the present invention;

FIG. 5 illustrates a side view of the lower edge side of the paper trimmer of the present invention;

FIG. 6 illustrates a right opposing side view of paper trimmer of the present invention; and

FIG. 7 illustrates a partial side view that shows the locking mechanism of the present invention.

### DETAILED DESCRIPTION OF THE INVENTION

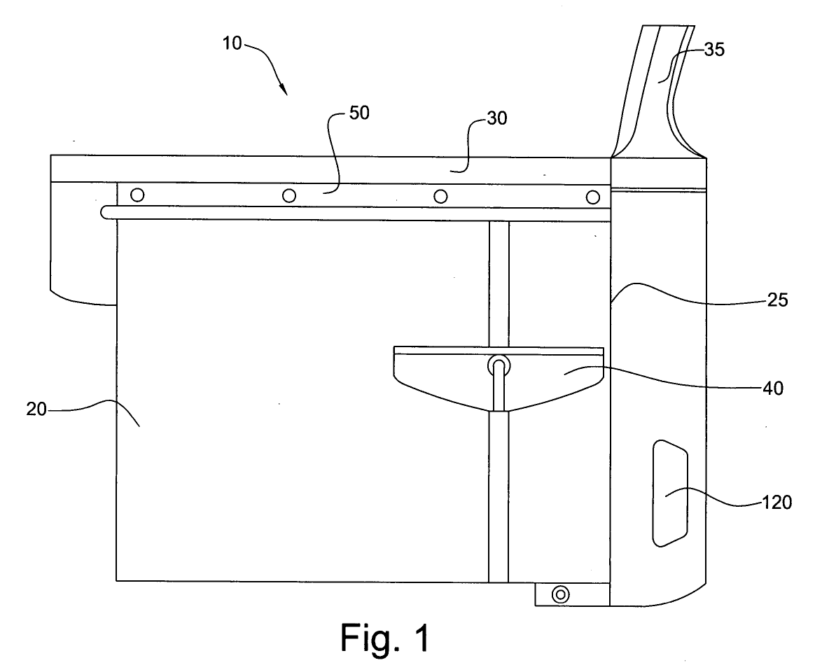

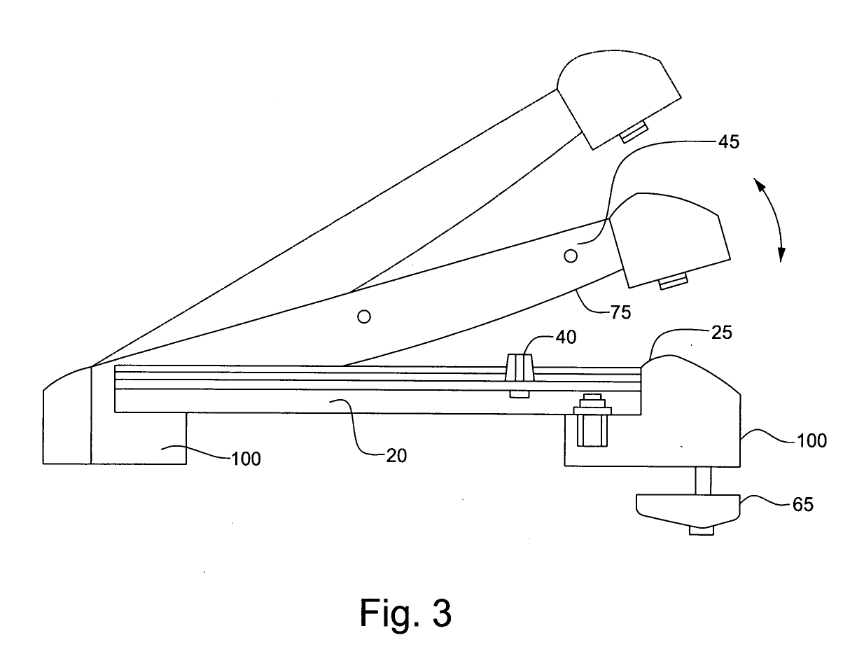

Referring to the figures and in particular FIG. 1, there is provided a guillotine style paper trimmer assembly according to the present invention, generally represented by reference numeral 10. The assembly 10 has a base 20 for supporting paper to be cut, a fixed blade 50 connected to a side edge of the base, a movable arm 30 connected to the base, and a handle 35 disposed on the movable arm. Movable arm 30 supports a horizontally disposed movable blade 45, as shown in FIG. 3.

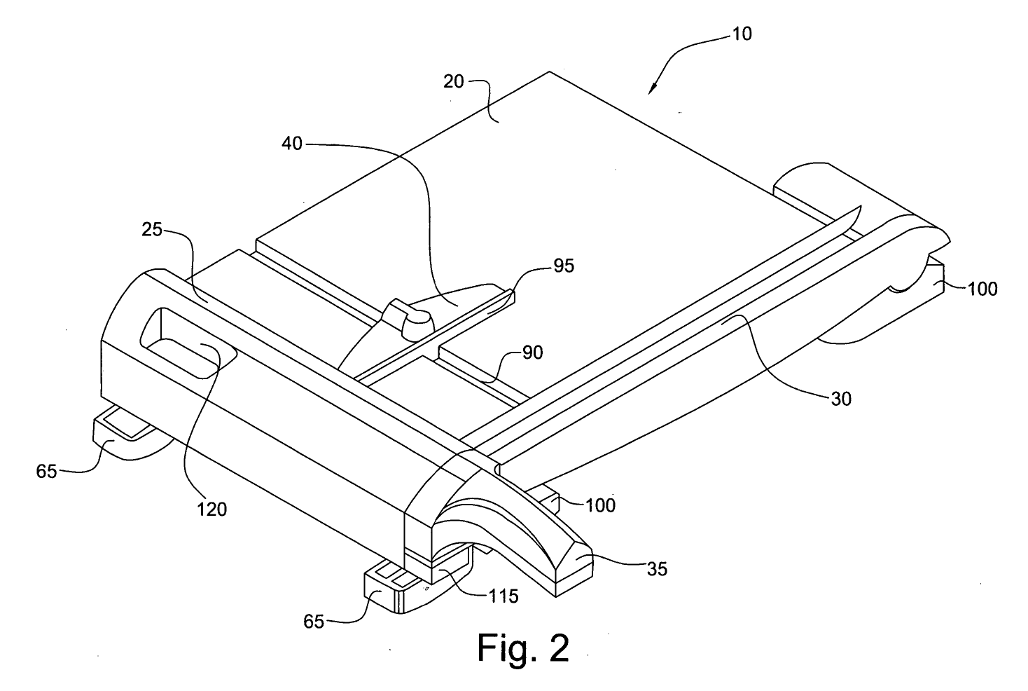

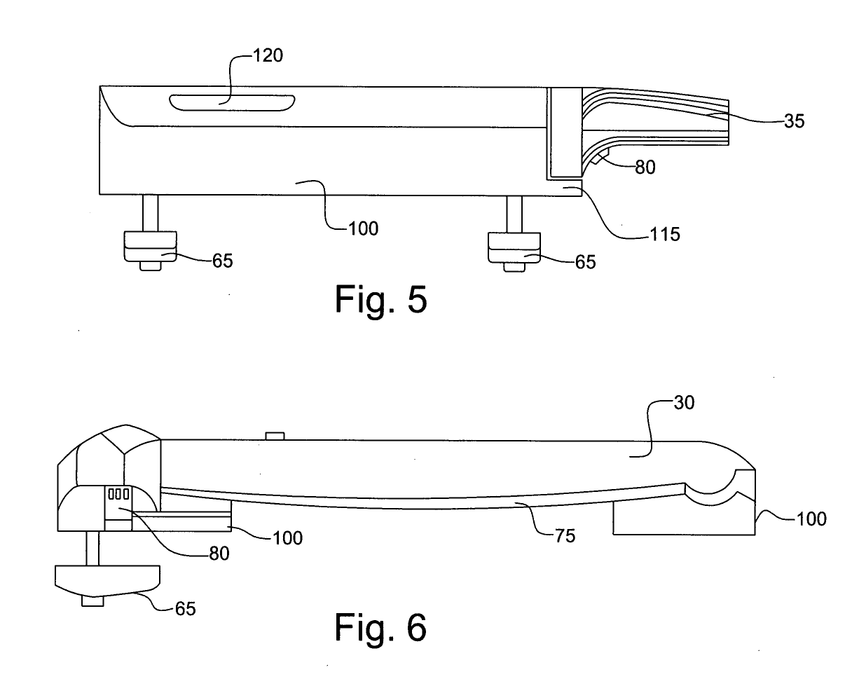

Referring to FIGS. 2 and 6, base 20 has supports 100 connected to the under side of base 20. Supports 100 are preferably connected to the upper edge of base 20 opposite the operator, and at the lower edge of the base, close to the operator. Optionally, supports 100 may be located on the opposite side edges of base 20. In the preferred embodiment, support 100, positioned on the lower edge of base 20 close to the operator, has a protruding edge 115 shown in FIGS. 2 and 5. Protruding edge 115 forms a conformal fit with movable arm 30, such that movable arm 30 rests on protruding edge 115 when the movable arm is in the neutral position.

Movable arm 30 is pivotally mounted to base 20. As is known in the art of guillotine style paper trimmers, movable arm 30, together with movable blade 45, works in a vertical plane transverse to the plane of base 20 and fixed blade 50 to produce a shearing cut. A combination torsion-compression spring, not shown, disposed in base 20 is connected to a stand-off bolt, and connected to movable arm 30, not shown. The spring resiliently biases movable arm 30 against fixed blade base 20 during a paper cutting operation by exerting a pull toward fixed blade 50 on the movable arm that in turn, exerts pressure on movable blade 45 necessary to enable contact between fixed blade 50 and the movable blade. The spring also functions as a counter-balance to maintain movable blade 45 in a fixed open position. The stand-off bolt provides spacing of movable blade 45 in a retracted position from fixed blade 50.

Referring to FIGS. 1 and 2, paper trimmer 10 also has an inverted paper orienting edge 25 disposed on the lower edge of base 20. Inverted paper orienting edge 25 provides for positioning of paper along the lower edge of base 20 close to the operator, and a distance away from the point of initial intersection of fixed blade 50 and movable blade 45. Positioning of the paper at a point away from the point of initial intersection of fixed blade 50 and movable blade 45 functions to prevent the application of torque forces to the paper during a cutting operation, thereby enhancing the precision of a cut. Inverted paper orienting edge 25 may be a wall component mounted or connected to the top side of base 20. In the preferred embodiment of the present invention, inverted paper orienting edge 25 is an integral part of support 100, located on the lower edge of base 20, close to the operator. In this embodiment, lower edge support 100 is an L-shaped block. The lower leg of L-shaped support 100 supports base 20. A portion of the vertical leg of L-shaped support 100 lies above the plane of base 20, thereby forming a ridge that functions as inverted paper orienting edge 25.

Paper trimmer 10 preferably has a blade guard 75, shown in FIGS. 3 and 6. Blade guard 75 is disposed between movable blade 45 and movable arm 30. Blade guard 75 preferably has the same general arc shape as movable blade 45. However, blade guard 75 extends a short distance below the horizontal bottom cutting edge of movable blade 45. Blade guard 75 prohibits contact by the operator with movable blade 45 when movable arm 30 is raised above base 20. Blade guard 75 may extend between about one-quarter to about one-twelfth of an inch below movable blade 45, and preferably extends about one-eighth of an inch below movable blade 45. Blade guard 75 may be formed of rubber, plastic, cardboard, blunt metal, or any other material that does not cut paper or skin. Blade guard 75 and movable blade 45 may be connected to movable arm 30 by any means or device known in the art.

Referring again to FIG. 1, movable arm 30 has a handle 35. Handle 35 is situated outwardly, and preferably perpendicular (to within a 3 to 4 degree tolerance) to the longitudinal axis of movable arm 30. The perpendicular disposition of handle 35 allows for smooth and controlled operation of movable blade 45, thereby facilitating precise cutting. The perpendicular disposition of handle 35 further allows for ergonomic operation of the paper trimmer 10. Handle 35 may optionally have a grip for positioning the operator's fingers thereabout.

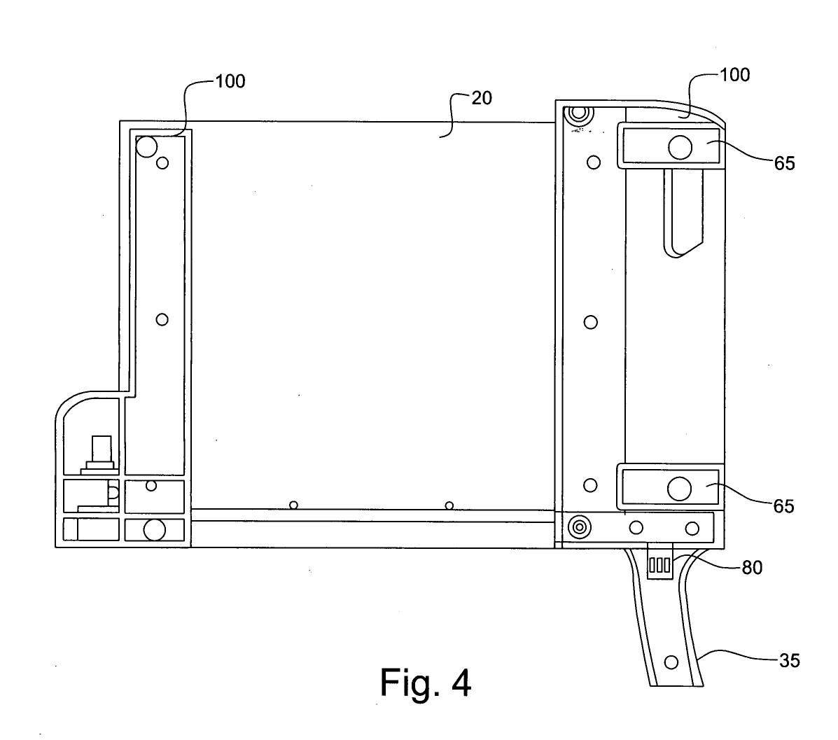

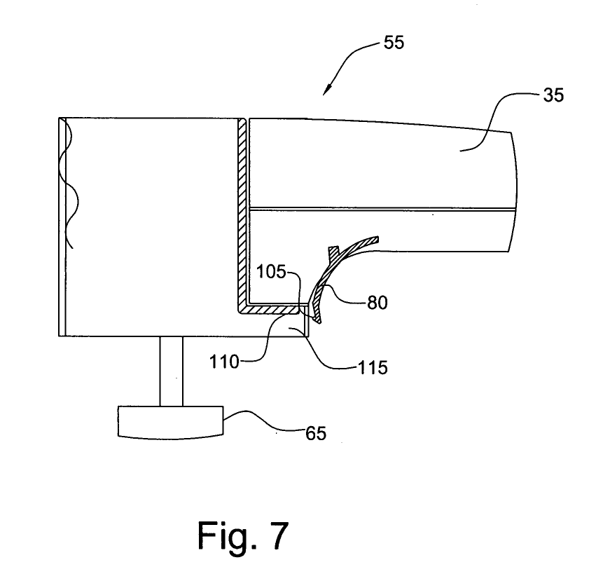

In a preferred embodiment shown in FIG. 7, paper trimmer 10 further has a locking mechanism 55. Locking mechanism 55 provides for selectively securing movable arm 30 against movement away from base 20. Locking mechanism 55 is automatically engaged when movable arm 30 is in a neutral position, as shown in FIG. 1. Locking mechanism 55 is disengaged when movable arm 30 is in an active position, as shown in FIG. 2. Movable arm 30 is positionable to an active position when a catch button 80 is depressed by the operator. Catch button 80 is located on the underside of handle 35, as shown in FIG. 4. Catch button 80 is preferably situated so as to be depressed when the operator grasps handle 35. Referring to FIG. 7, catch button 80 is pivotally connected to handle 35, such that the catch button may swing between a locked and an unlocked position. Catch button 80 has a lip 105 for forming a secure, conformal fit with a flange 110. Flange 110 is preferably disposed on protruding edge 115 of base 20 lower edge support 100. Lip 105 is released from flange 110 by pivotal movement of catch button 80. Thus, catch button 80 functions to release movable arm 30 when depressed by the operator, thereby enabling the operator to lift the movable blade to the active position.

Movable blade 45 and fixed blade 50 are preferably formed of stainless steel and coated with titanium nitride. Titanium nitride is bonded, preferably integrally, to the metal cutting surfaces of movable blade 45 and fixed blade 50 to increase the strength and durability of movable blade 45 and fixed blade 50. Titanium nitride is preferably applied to movable blade 45 and fixed blade 50 using a cathode arc plasma (CAP) deposition process. Titanium nitride is preferably applied to movable blade 45 and fixed blade 50 to a thickness in the range about 0.3 microns to about 2.0 microns.

In another preferred embodiment, base 20 or L-shaped support 100 may carry measuring indicia for facilitating the orienting of paper to be cut. The indicia may be graduations in inches or in metric equivalents thereof so as to be representative of distances from the cutting edge of fixed blade 50. Optionally, base 20 or L-shaped support 100 may have one or more recesses 120, shown in FIGS. 1 and 2, for storing office supplies such as tacks, paper clips or the like.

Referring to FIG. 3, paper trimmer 10 preferably has one or more mounting legs 65, for securing paper trimmer 10 to a table, desk or other work surface. Mounting leg 65 is preferably secured to base 20 by a threaded screw. Mounting legs 65 are preferably located on the underside of base 20 and preferably in each corner where the lower edge meets the opposing side edges of base 20. Clockwise turning of mounting legs 65 acts to secure paper trimmer 10 to a work surface. Mounting leg 65 may optionally be slidably receivable in a slot provided on the bottom surface of the base, or may be fixed to the bottom surface of the base and operate via a clamp and spring biasing operation.

Referring again to FIGS. 1 and 2, paper trimmer 10 preferably has a slidable paper guide 40. Slidable paper guide 40 is somewhat T-shaped in plan and has a flat surface 95 along its leading edge. Slidable paper guide 40 is disposed for movement left and right along a groove 90, located in the upper surface of base 20. Paper to be cut may be butted against the flat surface 95 for secure positioning during the cutting process. Slidable paper guide 40 may be removed if the paper to be trimmed is large in size.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

1. A trimmer comprising:
a base for supporting an object to be cut, said base having an upper edge and a lower edge opposite said upper edge;
an arm being connected to said base;
a cutting blade being positioned on said arm; and
a paper orienting edge being positioned on said lower edge of said base.

2. The trimmer of claim 1, wherein said arm can move in a vertical plane transverse to said base.

3. The trimmer of claim 1, further comprising a locking mechanism for securing said arm against movement away from said base.

4. The trimmer of claim 1, wherein said base has a measuring indicia.

5. The trimmer of claim 1, wherein said base has at least one storage recess.

6. The trimmer of claim 1, wherein said base has a paper guide for securing an object to be cut.

7. The trimmer of claim 6, wherein said paper guide moves in a channel in said board.

8. The trimmer of claim 1, wherein said cutting blade has a titanium-nitride coating.

9. The trimmer of claim 1, further comprising a blade guard.

10. The trimmer of claim 9, wherein said blade guard is between said cutting blade and said arm.

11. The trimmer of claim 9, wherein said blade guard extends beyond a cutting edge of said cutting blade.

12. The trimmer of claim 9, wherein said blade guard is formed of a material selected from the group consisting of rubber, plastic, cardboard, and metal.

13. The trimmer of claim 1, further comprising mounting legs for securing said base to a work surface.

14. The trimmer of claim 1, further comprising a spring for resiliently biasing said arm against said base during a paper cutting operation.

15. A trimmer comprising:
a base for supporting an object to be cut, said base having an upper edge and a lower edge opposite said upper edge;
an arm being connected to said base;
a cutting blade being positioned on said arm; and
a paper orienting edge positioned to reduce the angle to which said cutting blade must be lifted above the plane of paper to be cut,
wherein said cutting blade has a titanium-nitride coating.

16. The trimmer of claim 15, wherein said arm moves in a vertical plane transverse to said base.

17. The trimmer of claim 15, further comprising a locking mechanism for securing said arm against movement away from said base.

18. The trimmer of claim 15, wherein said board has a measuring indicia.

19. The trimmer of claim 15, wherein said base has at least one storage recess.

20. The trimmer of claim 15, wherein said base has a paper guide for securing an object to be cut.

21. A trimmer comprising:
a base for supporting an object to be cut, said base having an upper edge and a lower edge opposite said upper edge;
an arm being connected to said base;
a cutting blade being positioned on said arm;
a paper orienting edge being positioned on said lower edge of said base; and
a blade guard for preventing contact with said cutting blade.

22. The trimmer of claim 21, wherein said arm moves in a vertical plane transverse to said base.

23. The trimmer of claim 21, further comprising a locking mechanism for securing said arm against movement away from said base.

24. The trimmer of claim 21, wherein said board has a measuring indicia.

25. The trimmer of claim 21, wherein said base has at least one storage recess.

26. The trimmer of claim 21, wherein said base has a paper guide for securing an object to be cut.

27. The trimmer of claim 21, wherein said cutting blade further comprises a titanium-nitride coating.
